(19) United States
(12) Patent Application Publication
(10) Pub. No.: US 2008/0160936 A1
(43) Pub. Date: Jul. 3, 2008

(54) COMPUTER APPARATUS AND LOW POWER-CONSUMING DETECTION DEVICE OF WIRELESS TRANSMISSION ABILITY

(75) Inventors: Jia-Jie Chiang, Taoyuan Shien (TW); Kai-Wen Tien, Tainan City (TW); Ching-Hwa Yang, Taipei Shien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QUANTA COMPUTER INC., Tao Yuan Shien (TW)

(21) Appl. No.: 11/754,405

(22) Filed: May 29, 2007

(30) Foreign Application Priority Data
Dec. 28, 2006 (TW) 95149527

(51) Int. Cl. H04B 17/00

(52) U.S. Cl. 455/115.1

(57) ABSTRACT

A computer apparatus comprises a CPU, power supply unit, and low power-consuming detection device for wireless transmission ability. The power supply unit supplies a detection-device power as a detection event is triggered ; and a system power to the CPU as a power-on event is triggered. The detection device detects transmission ability of wireless communication connection of the computer apparatus in response to the detection device power. The detection device comprises a signal processing unit, an embedded low-power processor and a display unit. The signal processing unit receives a RF signal via the wireless communication connection and demodulating the RF signal to generate transmission data. The embedded low-power processor calculates dynamic data amount information, dynamic data flux information or dynamic transmission quality information of the wireless communication connection in response to the transmission data. The display unit is for displaying the above information.

This application claims the benefit of Taiwan application Serial No. 095149527, filed Dec. 28, 2006, the subject matter of which is incorporated herein by reference.

### BACKGROUND OF THE INVENTION

1. Field of the Invention

The invention relates in general to a low power-consuming detection device for detecting wireless transmission ability, and more particularly to a detection device, applied in a computer apparatus, for detecting transmission ability of a wireless communication connection before power-on of the computer apparatus.

2. Description of the Related Art

Along with technology development, wireless network has been widely applied in electronic products, such as notebook computers, mobile phones or personal digital assistants. Hardware devices of the conventional electronic products have to be controlled by executing system programs. For example, in order to detect transmission ability of the wireless network by using a wireless module of the conventional notebook computer, the notebook computer has to be powered on first and then the system programs are executed to control the wireless module to detect the transmission ability of the wireless network.

Since the transmission ability of the wireless network is significantly affected by the wireless network surroundings around the electronic device, searching and setting the electronic device in a place with good wireless channel quality is beneficial to increase the transmission ability of the wireless network. In practical application, most of the users have to constantly change their positions after the conventional electronic device is powered on for finding out a better position for wireless network transmission which accordingly result in some drawbacks such as usage inconvenience, poor transmission ability of its wireless network, lack of flexibility in detecting the transmission ability of wireless network, higher power consumption and short power lasting due to being repeatedly powered on and off.

### SUMMARY OF THE INVENTION

The invention is directed to a low power-consuming detection device for detecting wireless transmission ability for improving the drawbacks of the conventional electronic device with a wireless module about inconvenient usage, poor transmission ability of its wireless network, lack of flexibility in detecting the transmission ability of wireless network, higher power consumption and short power lasting due to being repeatedly powered on and off. In fact, the computer apparatus of the invention has the advantages of convenient usage, better transmission ability of wireless network, higher flexibility in detecting the transmission ability of wireless network, lower power consumption and longer power lasting.

According to a first aspect of the present invention, a computer apparatus is provided. The computer apparatus comprises a CPU, power supply unit, and low power-consuming detection device for detecting wireless transmission. The power supply unit is for supplying a detection device power to the detection device as a detection event is triggered and supplying a system power to the CPU as a power-on event is triggered. The detection device is for detecting transmission ability of a wireless communication connection of the computer apparatus in response to the detection device power. The detection device comprises a signal processing unit, a low-power embedded processor and a display unit. The signal processing unit is for receiving a radio frequency (RF) signal via the wireless communication connection and demodulating the RF signal to generate a piece of transmission data. The low-power processor is for calculating a dynamic data amount information, a dynamic data flux information or a dynamic transmission quality information of the wireless communication connection according to the transmission data. The display unit is for displaying the dynamic data amount information, the dynamic data flux information or the dynamic transmission quality information.

According to a second aspect of the present invention, a low power-consuming detection device is provided for detecting transmission ability of a wireless communication connection of a computer apparatus in response to a detection device power. The detection device comprises a power unit, signal processing unit, low-power processor and display unit. The power unit is for supplying the detection device power to enable the detection device in response to a detection event. The signal processing unit is for receiving a RF signal via the wireless communication connection and demodulating the RF signal to generate a piece of transmission data. The low-power processor is for calculating a dynamic data amount information, a dynamic data flux information or a dynamic transmission quality information of the wireless communication connection according to the transmission data. The display unit is for displaying the dynamic data amount information, the dynamic data flux information or the dynamic transmission quality information.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a computer apparatus according to a preferred embodiment of the invention.

FIG. 2 is a detailed diagram of the power supply unit 12 of FIG. 1.

FIG. 3 is a block diagram of the signal processing unit 17 of FIG. 1.

### DETAILED DESCRIPTION OF THE INVENTION

The low power-consuming detection device for detecting wireless transmission ability has an embedded low-power processor which can effectively detect the transmission ability of the present wireless network in response to a detection event provided by the user.

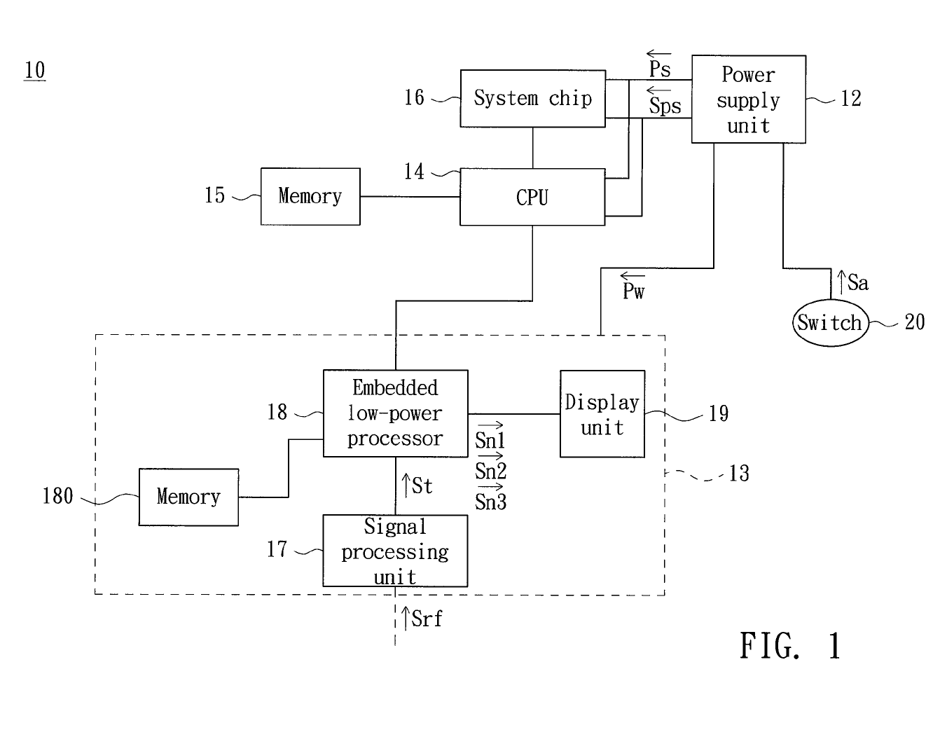

Referring to FIG. 1, a block diagram of a computer apparatus according to a preferred embodiment of the invention is shown. A computer apparatus 10 includes a power supply unit 12, low power consuming detection device 13 for detecting wireless transmission ability, central processing unit (CPU) 14, memory 15 and system chip 16. For example, the computer apparatus 10 of the invention is a notebook computer, tablet PC, personal digital assistant (PDA) or mobile phone. The memory 15 is a non-volatile memory for storing system programs and related application programs of the computer apparatus 10. The CPU 14 controls the computer apparatus 10 according to the program codes of the memory 15. The power supply unit 12 is for supplying a detection device power Pw as a detection event is triggered. In the embodiment, the detection event is, for example, triggered before the computer apparatus 10 being powered on.

The detection device 13 is for detecting transmission ability of a wireless communication connection of the computer apparatus 10 in response to the detection device power Pw. The wireless communication connection of the embodiment is a wireless network for instance. The detection device 13 includes a signal processing unit 17, an embedded low-power processor 18 and a display unit 19. The embedded low-power processor 18 is coupled to the signal processing unit 17 and display unit 19. For example, the embedded low-power processor 18 is for receiving radio frequency (RF) signals Srf via the wireless network and demodulating the RF signals to generate transmission data St. The format of the transmission data St (frame format), for example, complies with the specification of MAC 802.11 including control frame, data frame and management frame.

The embedded low-power processor 18 is for calculating dynamic data amount information, dynamic data flux information or dynamic transmission quality information of the wireless network according to the transmission data St. In the embodiment, the embedded low-power processor 18 is exemplified to calculate dynamic data amount information, dynamic data flux information or dynamic transmission quality information for illustration. The display unit 19 is for displaying the above information.

For example, the embedded low-power processor 18 determines the dynamic data amount information according to a ratio of an amount of data in each data frame successfully retrieved from the wireless network to a maximum data amount of the data frame. Therefore, when the dynamic data amount is a higher value, it represents that the amount of data in each data frame gets close to the maximum data amount, that is, the amount of data being conveyed in each data frame is larger.

For example, the embedded low-power processor 18 determines the dynamic transmission quality information according to a ratio of the number of data frames successfully retrieved from the wireless network to the maximum number of data frames that could be retrieved in a constant period. The constant period can be set by the user. Therefore, when the transmission quality information has a higher value, it represents that in the user-set period, the number of data frames accessible gets close to the maximum number of data frames accessible in the wireless network. As a result, the user can determine that the specification of the wireless network is IEEE 802.11a, IEEE 802.11b, IEEE 802.11c or IEEE 802.11n according to the dynamic transmission quality information.

For example, the embedded low-power processor 18 determines the dynamic data flux information according to a ratio of a total data amount of the data frames retrieved in the user-set period to a maximum data amount of the data frames. Therefore, when the dynamic data flux information has a higher value, it represents that the data flux of the wireless network in the user-set period gets close to the highest value.

For example, the embedded low-power processor 18 quantizes the above dynamic data amount information, dynamic data flux information and dynamic transmission quality information by increasing order into corresponding numeric data Sn1, Sn2, and Sn3 with a value 0˜10 and outputs the numeric data Sn1, Sn2 and Sn3 to the display unit 19. In the embodiment, the display unit 19 includes, such as, three sets of scales with 0˜10 for respectively displaying the present dynamic data amount information, dynamic data flux information and dynamic transmission quality information according to the numeric data Sn1˜Sn3.

Therefore, the user can effectively determines the transmission ability of the present wireless network according to the dynamic data amount information, dynamic data flux information or dynamic transmission quality information; and easily find out a better position of the wireless network channel environment in order to improve connection quality of the wireless network.

The embedded low-power processor 18 of the embodiment is, for example, connected to the memory 180 and the memory 180 stores system programs, application programs and parameters related the maximum data amount of a data frame, the number of data frames accessible per unit of time and the maximum data flux. The detection device 13 of the embodiment is, for example, an embedded system and the embedded low-power processor 18 is for controlling the detection device 13 to perform the above operations according to the program codes, parameters and data stored in the memory 180.

In the embodiment, the trigger of the detection event is, for example, related to a trigger signal Sa generated by a switch 20. The user switches on the switch 20 to generate the trigger signal Sa. At the time, the power supply unit 12 detects that the detection event is triggered and then provides the detection device power Pw. It has to be noted that the operation (openness and closeness) of the switch 20 is independent from whether the computer apparatus 10 is powered on or not.

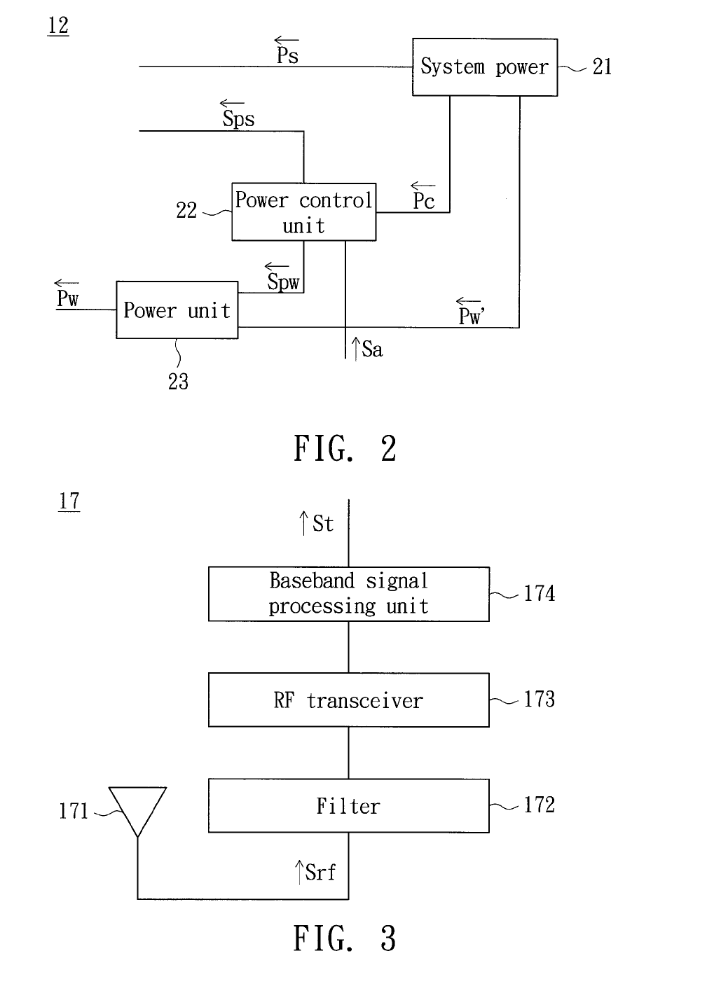

Referring to FIG. 2, a detailed diagram of the power supply unit 12 of FIG. 1 is shown. The power supply unit 12 of the embodiment includes, for example, a system power source 21, power control unit 22 and power unit 23. The system power source 21 is, for example, a battery or an adapter used as a main power source of the computer apparatus 10 for supplying a system power Ps to the system chip 16 and CPU 14 (see FIG. 1) as the system is powered on. The system power source 21 is for respectively supplying the power Pc and Pw′ to the power control unit 22 and power unit 23 for constantly detecting whether a trigger event, such as a power-on trigger event and a wireless-connection-ability detection event.

The power control unit 22 is, for example, an embedded controller (EC) of the computer apparatus 10 for providing a power control signal Sps to control and supply power for each hardware device in the computer apparatus 10. The power control unit 22 is further used for triggering the power control signal Spw, in response to the trigger signal Sa, to control the operation of the power unit 23. For example, when the power control unit 22 does not receive the trigger signal Sa, the power control unit 22 constantly provides the power control signal Spw to disable the power unit 23. As soon as the power control unit 22 receives the trigger signal Sa, the power control unit 22 stops outputting the power control signal Spw such that the power unit 23 is enabled to supply the detection device power Pw to the detection device 13.

Referring to FIG. 3, a block diagram of the signal processing unit 17 of FIG. 1 is shown. The signal processing unit 17 includes an antenna 171, a filter 172, a RF transceiver 173 and a baseband signal processing unit 174. An analog receiving terminal of the antenna 171, filter 172 and RF transceiver 173 can be any known pattern of receiving terminal structure module and the baseband processing unit 174 can be the known processing unit integrating a media access controller (MAC) and a baseband processor, which includes a bake receiver and modules for processing multi-path decay sampling, channel estimation, auto gain control, auto frequency control, transmission stability, signal synchronization, transmission rate match and cyclic redundancy check (CRC) algorithm.

Although the trigger event is exemplified to occur before the power on of the computer apparatus 10 for illustration in the embodiment, the trigger event can also be triggered after powering on of the computer apparatus 10. At the time, the power supply unit 12 still supplies the power Pw to the detection device 13. However, after power on, the CPU 14 replace the embedded low-power processor 18 in the detection device 13 to perform the above operations.

The low power-consuming detection device for wireless transmission ability of the embodiment is configured with an embedded low-power processor which can calculate the information, such as the dynamic data amount, dynamic data flux and dynamic transmission quality of the wireless communication connection according to data amount of data frames in each package of the received RF signals. The power control unit of the computer apparatus of the embodiment can supply the required power to the detection device before power on to enable the operation of the detection device. Therefore, the detection device and computer apparatus of the embodiment can effectively improve the drawbacks of the conventional electronic device with a wireless module about inconvenient usage, poor transmission ability of its wireless network, lack of flexibility in detecting transmission ability of wireless network, higher power consumption and short power lasting due to being repeatedly powered on and off. In fact, the computer apparatus of the invention has the advantages of higher convenient usage, better transmission ability of its wireless network, higher elasticity in detecting the transmission ability of wireless network, lower power consumption and longer power lasting.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer apparatus, coupled to another computer apparatus via a wireless communication connection, the computer apparatus comprising:
a central processing unit (CPU);
a power supply unit, for supplying a detection device power as a detection event is triggered and supplying a system power to the CPU as a power-on event is triggered; and
a low power-consuming detection device for detecting transmission ability of wireless communication connection of the computer apparatus in response to the detection device power, the detection device comprising:
a signal processing unit, for receiving a radio frequency (RF) signal via the wireless communication connection and demodulating the RF signal to generate a piece of transmission data;
a low-power processor, for calculating a dynamic data amount information, a dynamic data flux information or a dynamic transmission quality information of the wireless communication connection in response to the transmission data; and
a display unit, for displaying the dynamic data amount information, the dynamic data flux information or the dynamic transmission quality information.

2. The computer apparatus according to claim 1, wherein the low-power processor determines the dynamic data amount information according to a ratio of an amount of data in each data frame successfully retrieved from the wireless communication connection and a maximum data amount of the data frame.

3. The computer apparatus according to claim 1, wherein the low-power processor determines the dynamic transmission quality information according to a ratio of n data frames successfully retrieved from the wireless communication connection to a maximum m data frames per unit of time the wireless communication connection can access, wherein both m and n are natural number, and n is smaller than or equal to m.

4. The computer apparatus according to claim 3, wherein the low-power processor determines the dynamic data flux information according to a ratio of total data amount of the n data frames to a total data amount of the m data frames all with the maximum data amount.

5. The computer apparatus according to claim 1, wherein the power supply unit comprises a power unit for supplying the detection device power to the detection device as the detection event is triggered.

6. The computer apparatus according to claim 5, wherein the power supply unit comprises a power control unit for triggering the power unit to supply the detection device power to the detection device as the detection event is triggered.

7. The computer apparatus according to claim 6, wherein the power supply unit further comprises a system power unit for supplying the system power to the CPU.

8. A low power-consuming detection device for detecting transmission ability of wireless communication connection of a computer apparatus in response to a detection device power, the detection device comprising:
a power unit, for supplying a detection device power in response to a detection event to enable the detection device;
a signal processing unit, for receiving a RF signal via the wireless communication connection and demodulating the RF signal to generate a piece of transmission data;
a low-power processor, for calculating, in response to the transmission data, a dynamic data amount information, a dynamic data flux information or a dynamic transmission quality information of the wireless communication connection; and
a display unit, for displaying the dynamic data amount information, the dynamic data flux information or the dynamic transmission quality information.

9. The detection device according to claim 8, wherein the low-power processor determines the dynamic data amount information according to a ratio of an amount of data in each data frame successfully retrieved from the wireless communication connection to a maximum data amount of the data frame.

10. The detection device according to claim 8, wherein the low-power processor determines the dynamic transmission quality information according to a ratio of n data frames successfully retrieved from the wireless communication connection to a maximum m data frames per unit of time the wireless communication connection can access, wherein both m and n are natural number, and n is smaller than or equal to m.

11. The detection device according to claim 10, wherein the low-power processor determines the dynamic data flux information according to a ratio of a total data amount of the n data frames and a total data amount of the m data frames all with the maximum data amount.
